(19) United States
(12) Patent Application Publication
(10) Pub. No.: US 2019/0057475 A1
(43) Pub. Date: Feb. 21, 2019

(54) SYSTEM AND METHOD FOR PREDICTING WAIT TIME

(71) Applicant: Beijing Didi Infinity Technology and Development Co., Ltd., Beijing (CN)

(72) Inventors: Xiang LI, Beijing (CN); Kehua SHENG, Beijing (CN); Zhan WANG, Beijing (CN); Zhiqiang ZHOU, Beijing (CN); Niping ZHANG, Beijing (CN)

(73) Assignee: Beijing Didi Infinity Technology and Development Co., Ltd., Beijing (CN)

(21) Appl. No.: 15/846,030

(22) Filed: Dec. 18, 2017

(30) Foreign Application Priority Data
Aug. 16, 2017 (CN) 201710702597.8

(51) Int. Cl. G06Q 50/30; G06N 5/02

(52) U.S. Cl. CPC G06Q 50/30; G06N 5/022

(57) ABSTRACT

Embodiments of the disclosure provide methods and systems for predicting wait time of a transportation service request. The method includes receiving, from a terminal device, the transportation service request. The method further includes determining, by a processor, a first queue position of the transportation service request at a first time point. The method also includes determining, by the processor, a second queue position of the transportation service request at a second time point. The method also includes determining, by the processor, a request processing speed based on the first and second queue positions and the first and second time points. The method also includes determining, based on the request processing speed and the second queue position of the transportation service request, the predicted wait time. The method also includes providing, to the terminal device, the predicted wait time of the transportation service request.

### CROSS REFERENCE TO RELATED APPLICATION

The present application is based on and claims the benefits of priority to Chinese Application No. 201710702597.8, filed Aug. 16, 2017, the entire contents of which are incorporated herein by reference.

### TECHNICAL FIELD

The present disclosure relates to methods and systems for providing carpool service. More particularly, the disclosure relates to methods and systems for predicting wait time for carpool service request.

### BACKGROUND

An online hailing platform may be used to match drivers who can offer car rides and passengers who need transportation services. After a service request is received from the passenger, a driver will be dispatched to pick him up and fulfill the request. Carpooling is a way to share a car ride so that one driver provides transportation service to multiple passengers simultaneously. Thus, carpooling may help balance supply and demand, and reduce costs and carbon emissions.

When the online hailing platform receives transportation service requests more than the transportation capacity that the service vehicles can offer at the current moment (e.g., in rush hours), the transportation service requests can be placed in a queue. The transportation service requests can then be assigned to the service vehicles according to a predetermined regulation. Therefore, in rush hours, a passenger may have to wait in a queue until his transportation service request is assigned to a vehicle.

Factors like the service provider availability, the traffic condition, and the number of previous requests in the queue can affect the waiting time for a transportation service request waiting in the queue. Conventionally, a passenger has little information associated with his transportation service request waiting in the queue. For example, the passenger cannot estimate his waiting time. Lack of knowledge related to the wait may increase the passenger's anxiety, and complicate his schedule. For example, the passenger may have a meeting to attend or a plane to catch, and he would not be able to decide if he has to switch to another transportation service, such as metro or bus, without knowing how fast he can get his ride.

The disclosed systems and methods are designed to address at least the above discussed issues.

### SUMMARY

Embodiments of the disclosure provide a computer-implemented method for predicting wait time of a transportation service request. The method includes receiving, from a terminal device, the transportation service request. The method further includes determining, by a processor, a first queue position of the transportation service request at a first time point. The method also includes determining, by the processor, a second queue position of the transportation service request at a second time point. The method also includes determining, by the processor, a request processing speed based on the first and second queue positions and the first and second time points. The method also includes determining, based on the request processing speed and the second queue position of the transportation service request, the predicted wait time. The method also includes providing, to the terminal device, the predicted wait time of the transportation service request.

Embodiments of the disclosure further provide a system for providing transportation service. The system includes a communication interface, a memory, and at least one processor, coupled to the communication interface and the memory. The at least one processor may be configured to determine a first queue position of the transportation service request at a first time point. The at least one processor may be further configured to determine a second queue position of the transportation service request at a second time point. The at least one processor may also be configured to determine a request processing speed based on the first and second queue positions and the first and second time points. The at least one processor may also be configured to determine, based on the request processing speed and the second queue position of the transportation service request, the predicted wait time. The at least one processor may also be configured to provide, to the terminal device, the predicted wait time of the transportation service request.

Embodiments of the disclosure further provide a non-transitory computer-readable medium that stores a set of instructions, when executed by at least one processor of an electronic device, cause the electronic device to perform a method for predicting wait time of a transportation service request. The method includes receiving, from a terminal device, the transportation service request. The method further includes determining, by a processor, a first queue position of the transportation service request at a first time point. The method also includes determining, by the processor, a second queue position of the transportation service request at a second time point. The method also includes determining, by the processor, a request processing speed based on the first and second queue positions and the first and second time points. The method also includes determining, based on the request processing speed and the second queue position of the transportation service request, the predicted wait time. The method also includes providing, to the terminal device, the predicted wait time of the transportation service request.

It is to be understood that both the foregoing general description and the following detailed description are exemplary and explanatory only and are not restrictive of the invention, as claimed.

### BRIEF DESCRIPTION OF DRAWINGS

The accompanying drawings, which comprise a part of this specification, illustrate several embodiments and, together with the description, serve to explain the disclosed principles.

FIG. 1 illustrates a schematic diagram of an exemplary system for providing transportation service, consistent with disclosed embodiments.

FIG. 2 is a flowchart of an exemplary method for predicting wait time.

FIGS. 3A-3C illustrate the queue position of a request at time point t1, t2, and t3 respectively, consistent with disclosed embodiments.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

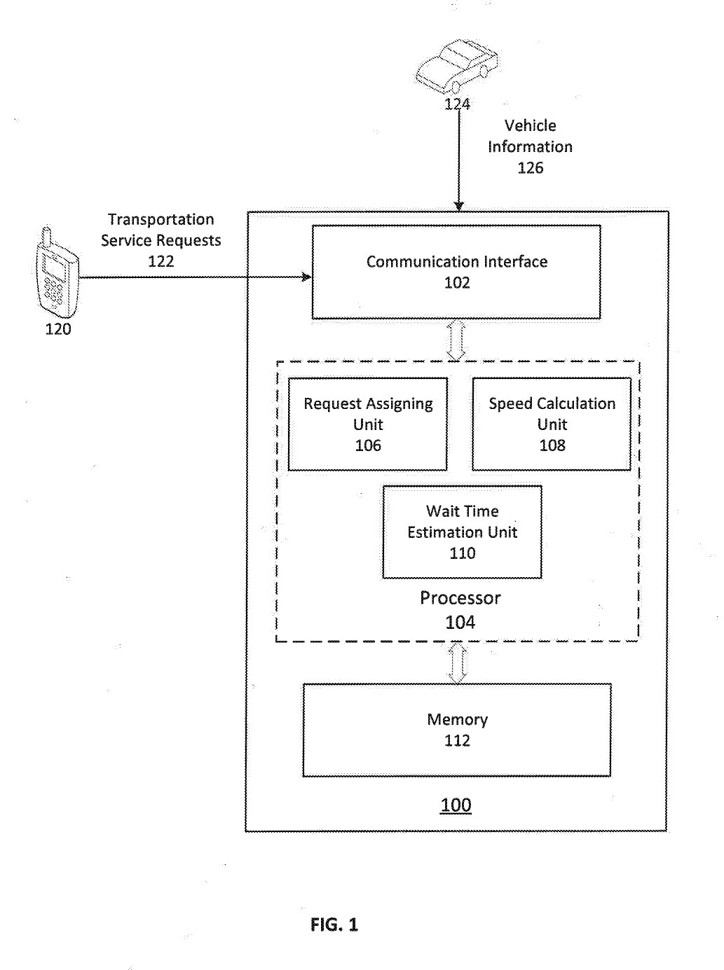

FIG. 1 illustrates a schematic diagram of an exemplary device 100 for providing transportation service, consistent with disclosed embodiments.

Device 100 can be a general-purpose server or a proprietary device specially designed for providing transportation service. It is contemplated that, device 100 can be a separate system (e.g., a server) or an integrated component of a server. Because processing transportation service may require significant computation resources, in some embodiments, device 100 may be preferably implemented as a separate system. In some embodiments, device 100 may include sub-systems, some of which may be remote.

In some embodiments, as shown in FIG. 1, device 100 may include a communication interface 102, a processor 104, and a memory 112. Processor 104 may further include multiple modules, such as a request assigning unit 106, a speed calculation unit 108, a wait time estimation unit 110. These modules (and any corresponding sub-modules or sub-units) can be hardware units (e.g., portions of an integrated circuit) of processor 104 designed for use with other components or to execute a part of a program. The program may be stored on a computer-readable medium, and when executed by processor 104, it may perform one or more functions. Although FIG. 1 shows units 106-110 all within one processor 104, it is contemplated that these units may be distributed among multiple processors located near or remotely with each other. In some embodiments, device 100 may be implemented in the cloud, or on a separate computer/server.

Communication interface 102 may be configured to receive a transportation service request 122 in an area from a remote passenger terminal 120, and receive vehicle information 126 of at least one service vehicle 124 from the at least one service vehicle 124 in the area. The remote passenger terminal 120 can be any suitable device that can interact with a passenger, e.g., a smart phone, a tablet, a wearable device, a computer, or the like. Transportation service request 122 can include a current location of the passenger, an origin and a destination of the requested transportation service, a request time, or the like. Generally, the origin of the requested transportation service can be the same as or substantially close to a location of the remote passenger terminal 120. However, it is contemplated that, the origin of the requested transportation can also differ from the location of the remote passenger terminal 120, even if transportation service request 122 is sent from terminal 120. For example, a user can request a transportation service from a computer for his/her friend, who is distant from this user. Device 100 can generate an estimated price and send the estimated price back to the terminal for displaying to the passenger. Similarly, device 100 can predict a wait time and send the predicted wait time back to the terminal for displaying to the passenger. Vehicle information 126 of the at least one service vehicle can also be received by communication interface 102. The service vehicles can include taxi cars and private cars which have been connected to the online hailing platform. It is contemplated that, the service vehicles can also be autonomous vehicles. Vehicle information 126 can include at least one of locations, capacities, current driving directions, vehicle models, or other features of the service vehicles.

In some embodiments, communication interface 102 can be an integrated services digital network (ISDN) card, cable modem, satellite modem, or a modem to provide a data communication connection. As another example, communication interface 102 can be a local area network (LAN) card to provide a data communication connection to a compatible LAN. Wireless links can also be implemented by communication interface 102. In such an implementation, communication interface 102 can send and receive electrical, electromagnetic or optical signals that carry digital data streams representing various types of information via a network. The network can typically include a cellular communication network, a Wireless Local Area Network (WLAN), a Wide Area Network (WAN), or the like.

Request assigning unit 106 can be configured to assign the transportation service request to a queue. Before the assignment, request assigning unit 106 may further determine whether the queuing should be activated. In some embodiments, request assigning unit 106 may queue the transportation service requests when the number of transportation service requests exceeds the capacity provided by the service vehicles by a predetermined value, or when the transportation service request is made within a predetermined time range. For example, the predetermined time range can include rush hours (e.g., 8:00-9:00 AM and 5:00-7:00 PM).

Speed calculation unit 108 may be configured to determine the speed transportation requests in the queue are processed. In some embodiments, the speed can be determined by dividing the difference of the queue positions at two time points by the difference of the two time points. In some embodiments, multiple speeds may be calculated and an average speed may be determined based thereon as the estimated request processing speed.

Wait time estimation unit 110 may predict an estimated wait time for the transportation service request to be fulfilled. In some embodiments, the estimated wait time can be determined by dividing the queue position of the transportation service request by the calculated request processing speed or the average speed. The estimated wait time may be provided to the passengers to assist the passengers to use the proper form of transportation to get to the destination, or to plan their schedules accordingly if they decide to wait for the ride. For example, the passenger may choose to ride the metro instead if he has a plane or meeting to catch. Alternatively, the passenger may rebook the flight or reschedule the meeting, if he decides the requested transportation service is still the best option.

The above embodiments of device 100 can provide information and options for a passenger waiting for transportation service, and allow the passenger to make a better decision based on the information and options. Thus, the above embodiments of device 100 can improve the user experience of transportation service, especially when a passenger may have to wait for the transportation service.

Another aspect of the disclosure is directed to a method for predicting wait time for transportation service request.

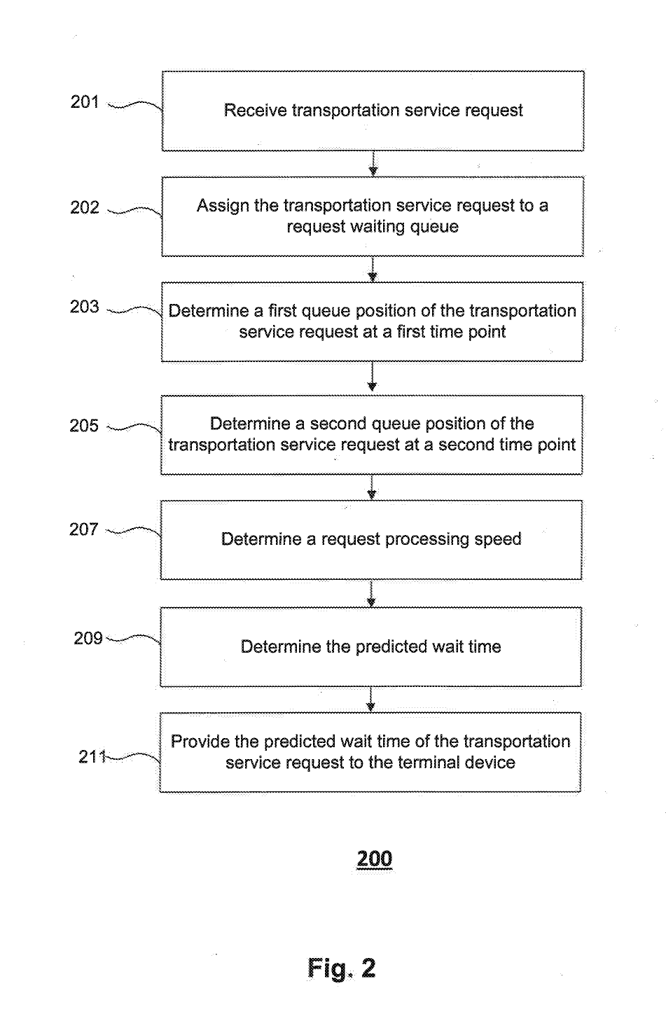

FIG. 2 is a flowchart of an exemplary method 200 for predicting wait time, consistent with disclosed embodiments. For example, method 200 may be implemented by device 100 including at least one processor, and method 200 may include steps 201-211 as described below.

At step 201, device 100 may receive a transportation service request from a remote passenger terminal. The transportation service request can include a current location of the passenger, an origin and a destination of the requested transportation service, or the like. At step 202, device 100 may assign the transportation service request to a request waiting queue.

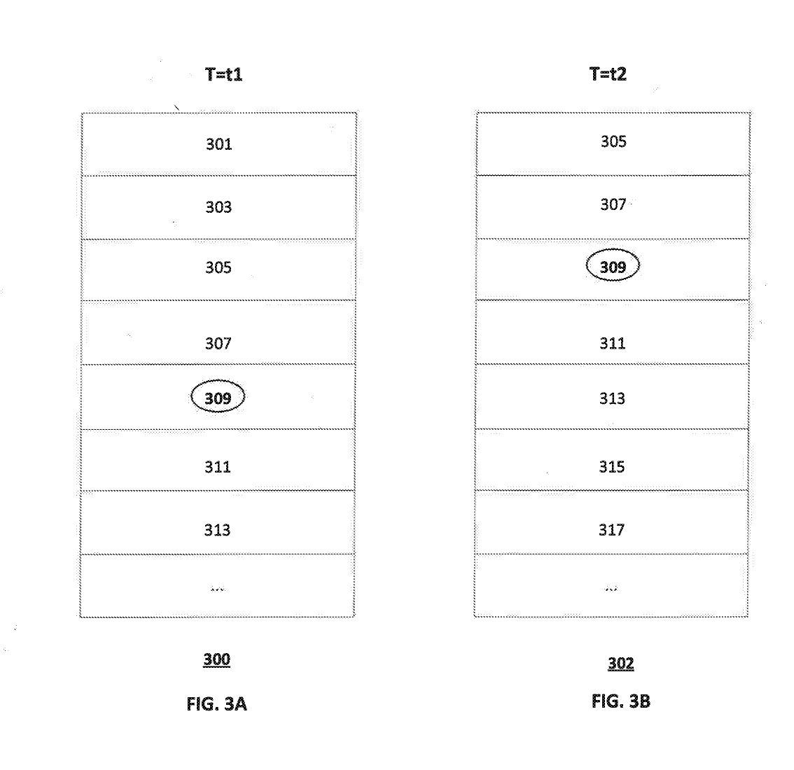

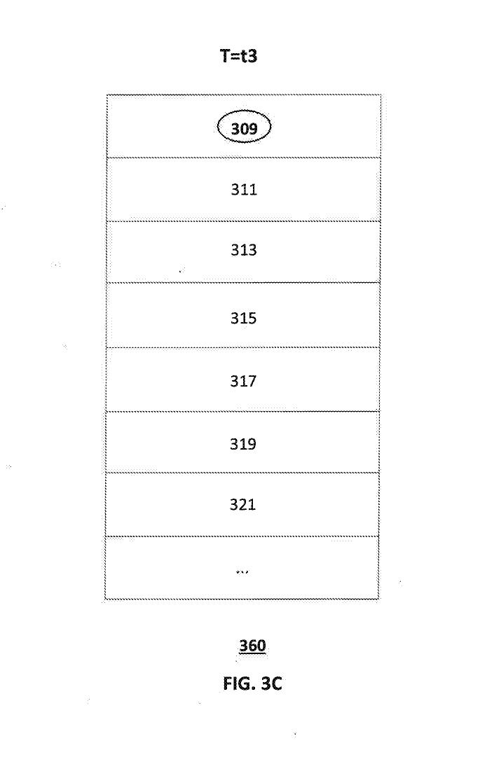

FIG. 3A illustrates an exemplary queue 300 at time point t1, consistent with disclosed embodiments. Requests 301, 303, 305, 307, 309, 311, and 313 are placed in queue 300, with request 301 being first in line. Queue 300 may be first in first out (FIFO). That is, a request in queue 300 (e.g., request 301) will be assigned to a driver first. After that, the next request (e.g., request 303) will be assigned.

Similarly, FIG. 3B illustrates another exemplary queue 302 at time point t2, consistent with disclosed embodiments. Time point t2 is some time after time point t1. For example, as shown in FIG. 3B, time point t2 is a time when both requests 301 and 303 have been assigned, and request 305 becomes first in line.

At step 203, device 100 may determine a first queue position of the transportation service request at a first time point. For example, in FIG. 3A, device 100 may determine that request 309 is the fifth queue position in queue 300 at time point t1. At step 205, device 100 may determine a second queue position of the transportation service request at a second time point. For example, in FIG. 3B, device 100 may determine that request 309 has moved to the third queue position at time point t2.

At step 207, device 100 may determine a request processing speed based on the first and second queue positions and the first and second time points. For example, in FIGS. 3A and 3B, from time point t1 to time point t2, request 309 moves forward two queue positions, from the fifth to the third in line. To determine the request processing speed, device 100 may divide the difference of the first and second queue positions by the difference of the first and second time points. That is, in FIGS. 3A and 3B, the request processing speed for request 309 would be two queue positions per (t2-t1). Furthermore, similarly, device 100 may determine more than one request processing speeds using different combinations of time points. For example, in FIG. 3C, at time point t3, request 309 moves to the first queue position in queue 360. A second request processing speed for request 309 may be determined by dividing the difference of the queue positions at t3 and t2 by the difference of time points t3 and t2. After the request processing speeds are determined, device 100 may store the speeds in memory 112. In addition, device 100 may store a data record associated with a transportation request in memory 112, including the time points, the queue positions at the time points, and the request processing speeds corresponding to the time points, etc.

In some embodiments, device 100 may determine an average request processing speed based on the plurality of request processing speeds. For example, device 100 may calculate an average order processing speed,

$${V}_{avg} = ( preSpeed + \frac{preRank - Rank}{currTime - preCheckTime} ) / 2 ,$$

wherein V_{avg} is the average request processing speed, preSpeed is a previously determined request processing speed, preCheckTime is a previous time point, currTime is a current time point, Rank is a first queue position of a service request at the previous time point, preRank is a second queue position of the service request at the current time point.

For example, preSpeed may refer to a first request processing speed determined using positions of request 309 at times points t1 and t2. Comparing FIGS. 3A and 3B, the request processing speed for service request 309 would be two queue positions per (t2−t1). Then the current processing speed may be a second request processing speed determined using positions of request 309 at times points t2 (preCheckTime) and t3 (currTime). Applying the equation above, average request processing speed for request 309, would be

$$( \frac{2 positions}{t 2 - t 1} + \frac{2 positions}{t 3 - t 1} ) / 2.$$

In some embodiments, device 100 may average multiple historical processing speeds to obtain the average request processing speed

$${V}_{avg} = \frac{1}{L} {\sum }_{1}^{L} {V}_{i} ,$$

wherein L is the number of request processing speeds, and Vᵢ is the request processing speed at different time points.

Furthermore, device 100 may select a predetermined number of most recent request processing speeds to calculate the average request processing speed. For example, device 100 may determine

$$L in {V}_{avg} = \frac{1}{L} {\sum }_{1}^{L} {V}_{i} ,$$

as a number less than the total processing speeds available. For example, L may be set as 10 while there may be more than 10 request processing speeds stored in the database.

In some embodiments, when the number of the plurality of request processing speeds is less than a predetermined value, device 100 may run a check to see if there is not any request processing speed. When device 100 determines there is no request processing speed, device may set a predetermined value as an average request processing speed. The predetermined value may be generated automatically by processor 104, based on historical request processing speeds. Alternatively, the predetermined value may be assigned manually.

In addition, device 100 may generate a set to store queue positions of a request. Similarly, device 100 may generate a set to store request processing speeds. Both sets may be a sub set of one another, or both sets may be independent from one another.

In some embodiments, when the queue position of a request is within a predetermined range or when the queue position changes, device 100 may remove a request processing speed that is placed first in the set. Alternatively, device 100 may erase the request processing speed from memory 112. Also, after a request processing speed is determined, device 100 may add the request processing speed to the end of the set.

In some embodiments, when the number of the plurality of request processing speeds is greater than a predetermined value, device 100 may remove a request processing speed that is placed first in the set. Alternatively, device 100 may erase the request processing speed from memory 112. Also, after a request processing speed is determined, device 100 may add the request processing speed to the end of the set.

In some embodiments, device 100 may update the request processing speed at a predetermined frequency. For example, for a predetermined frequency of once every 30 seconds, the time difference between t1 and t2 would be 30 seconds. Accordingly, device 100 may calculate a request processing speed once every 30 second. In some embodiments, based on the calculated request processing speeds, device 100 may calculate an updated average request processing speed and determine an updated wait time. Device 100 may provide the updated wait time of the transportation service request to terminal device 120.

At step 209, device 100 may determine the predicted wait time, based on the request processing speed and the second queue position of the transportation service request. Dividing the second queue position by the request processing speed, device 100 may determine the predicted wait time. For example, as shown in FIG. 3B, request 309 is at the third queue position. Based on the calculated processing speed of 2 positions/(t2−t1), the estimated wait time can be determined as 3 positions/(2 positions/(t2−t1))=1.5*(t2−t1). After a wait time is determined, device 100 may store the wait time in memory 112.

At step 211, device 100 may provide the predicted wait time of the transportation service request to the terminal device 120 for displaying to the passenger. In some embodiments, device 100 may also provide the second queue position of the transportation service request to the terminal device 120 for displaying to the passenger. With the information, passengers may make plans based on the wait time.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for predicting wait time of a transportation service request, comprising:
receiving, from a terminal device, the transportation service request;
determining, by a processor, a first queue position of the transportation service request at a first time point;
determining, by the processor, a second queue position of the transportation service request at a second time point;
determining, by the processor, a request processing speed based on the first and second queue positions and the first and second time points;
determining, based on the request processing speed and the second queue position of the transportation service request, the predicted wait time; and
providing, to the terminal device, the predicted wait time of the transportation service request.

2. The method of claim 1, further comprising:
determining a plurality of request processing speeds at a plurality of time points; and
determining an average request processing speed based on the plurality of request processing speeds.

3. The method of claim 2, further comprising:
selecting a predetermined number of most recent request processing speeds from the plurality of request processing speeds; and
determining an average request processing speed based on the predetermined number of most recent request processing speeds.

4. The method of claim 2, further comprising:
obtaining a previously determined request processing speed for the transportation service request; and
determining an average request processing speed based on the previously determined request processing speed and the request processing speed.

5. The method of claim 1, further comprising:
storing a data record including the second time point, the request processing speed, the second queue position, and the predicted wait time.

6. The method of claim 1, further comprising:
updating the request processing speed at a predetermined frequency; and
providing, to the terminal device, an updated wait time of the transportation service request.

7. The method of claim 1, further comprising:
providing, to the terminal device, the second queue position of the transportation service request.

8. A system for providing transportation service, comprising:
a communication interface;
a memory; and
at least one processor, coupled to the communication interface and the memory, configured to:
determine a first queue position of the transportation service request at a first time point;
determine a second queue position of the transportation service request at a second time point;
determine a request processing speed based on the first and second queue positions and the first and second time points;
determine, based on the request processing speed and the second queue position of the transportation service request, the predicted wait time; and
provide, to the terminal device, the predicted wait time of the transportation service request.

9. The system of claim 8, wherein the at least one processor is further configured to:
determine a plurality of request processing speeds at a plurality of time points; and
determine an average request processing speed based on the plurality of request processing speeds.

10. The system of claim 8, wherein the at least one processor is further configured to:
select a predetermined number of most recent request processing speeds from the plurality of request processing speeds; and
determine an average request processing speed based on the predetermined number of most recent request processing speeds.

11. The system of claim 8, wherein the at least one processor is further configured to:
obtain a previously determined request processing speed for the transportation service request; and
determine an average request processing speed based on the previously determined request processing speed and the request processing speed.

12. The system of claim 8, wherein the at least one processor is further configured to:
store a data record including the second time point, the request processing speed, the second queue position, and the predicted wait time, in the memory.

13. The system of claim 8, wherein the at least one processor is further configured to:
update the request processing speed at a predetermined frequency; and
provide, to the terminal device, an updated wait time of the transportation service request.

14. The system of claim 8, wherein the at least one processor is further configured to:
provide, to the terminal device, the second queue position of the transportation service request.

15. A non-transitory computer-readable medium storing instructions which, when executed, cause at least one processor to perform a method for predicting wait time of a transportation service request, the method comprising:
receiving, from a terminal device, the transportation service request;
determining, by a processor, a first queue position of the transportation service request at a first time point;
determining, by the processor, a second queue position of the transportation service request at a second time point;
determining, by the processor, a request processing speed based on the first and second queue positions and the first and second time points;
determining, based on the request processing speed and the second queue position of the transportation service request, the predicted wait time; and
providing, to the terminal device, the predicted wait time of the transportation service request.

16. The non-transitory computer-readable medium of claim 15, wherein the method further comprises:
determining a plurality of request processing speeds at a plurality of time points; and
determining an average request processing speed based on the plurality of request processing speeds.

17. The non-transitory computer-readable medium of claim 15, wherein the method further comprises:
selecting a predetermined number of most recent request processing speeds from the plurality of request processing speeds; and
determining an average request processing speed based on the predetermined number of most recent request processing speeds.

18. The non-transitory computer-readable medium of claim 15, wherein the method further comprises:
obtaining a previously determined request processing speed for the transportation service request; and
determining an average request processing speed based on the previously determined request processing speed and the request processing speed.

19. The non-transitory computer-readable medium of claim 15, wherein the method further comprises:
storing a data record including the second time point, the request processing speed, the second queue position, and the predicted wait time.

20. The non-transitory computer-readable medium of claim 15, wherein the method further comprises:
updating the request processing speed at a predetermined frequency; and
providing, to the terminal device, an updated wait time of the transportation service request.
